(19) United States
(12) Patent Application Publication
(10) Pub. No.: US 2009/0202320 A1
(43) Pub. Date: Aug. 13, 2009

(54) Binding Device

(76) Inventor: Peter Harvey, Queensland (AU)

Correspondence Address: DILWORTH & BARRESE, LLP, 1000 WOODBURY ROAD, SUITE 405, WOODBURY, NY, 11797, US

(21) Appl. No.: 12/083,413

(22) PCT Filed: Oct. 6, 2006
(86) PCT No.: PCT/AU2006/001468

§ 371 Date: Mar. 16, 2009

(30) Foreign Application Priority Data
Oct. 13, 2005 (AU) 2005905652

(51) Int. Cl. B42B 9/00

(52) U.S. Cl. 412/33

(57) ABSTRACT

A binding device (300) is useful for securing materials such as booklets and magazines in a ring binder. The device (300) has a perforated side (305) including holes (315) for securing the device (300) in a ring binder. A clamping side (310) includes an upper jaw (320) and a lower jaw (325). The upper jaw (320) and the lower jaw (325) each include a component (335) of a snap fit mechanism for securing the upper jaw (320) and the lower jaw (325) together along a longitudinal axis of the device (300).

### FIELD OF THE INVENTION

The invention relates to a binding device for securing materials such as booklets, pamphlets or magazines. In particular, although not exclusively, the invention relates to a binding device for securing materials in a ring binder.

### BACKGROUND TO THE INVENTION

Small pamphlets, user manuals, booklets and magazines are commonly used by organizations to communicate with customers. For example banks, credit card companies and insurance companies frequently provide policy statements and terms and conditions in small booklet form. Such booklets are provided in various sizes but generally have the thickness of a typical magazine and an area that varies from that of an A4 sheet of paper to an area that is smaller than that of an A4 sheet. The popularity of such booklets means that an average household or business possesses many such booklets including very important information that should be safeguarded. However storing such booklets in a typical file cabinet folder is problematic because the booklets tend to get lost at the bottom of a file. Also, punching holes through the booklets for use in ring binders or other binding devices is undesirable because the booklets often include reduced margins and small text fonts where punched holes can destroy significant amounts of information. Many booklets are also too thick for conveniently punching holes through them with a standard two or three hole paper punch. Further, storing such booklets separately from a standard paper file that includes associated information, printed on for example standard A4 papers, is inconvenient as the booklets and the papers often need to be reviewed together.

Two and three-ring binders are universally adopted binding devices for conveniently, securely, and removably storing papers. Such binders enable papers to be stored for example in standard filing cabinets or on book shelves. The binders securely hold papers in place so that there is no risk of loose papers falling out of the binders, and yet the rings are easily and quickly opened and closed to allow insertion and removal of individual paper sheets.

The prior art does not include any convenient and effective methods or devices for storing the small booklets described above in ring binders. The prior art includes the use of inserts with pockets where the inserts include holes for use in ring binders, and the pockets are designed to receive various materials such as booklets. However the pockets generally do not securely hold the booklets, thus if a ring binder is inverted the booklets easily slide out of the pockets. Where the inserts include zippers or other retaining mechanisms for the pockets, it is often awkward to insert and remove booklets and the booklets cannot be reviewed while they are secured in the pockets. Below are described additional specific prior art devices for securing materials, including booklets, in ring binders.

U.S. Pat. No. 4,127,690 to Schleifenbaum et al. discloses a filing strip including adhesive along one edge of the strip for attaching a document to be filed. Holes along an adjacent edge of the filing strip are then used to secure the strip in a ring binder. However, the adhesive edge is a non-ideal method for storing booklets as the adhesive binds only to an outer sheet of the booklet, and the weight of the booklet or other force on the booklet can cause the outer sheet to tear.

U.S. Pat. No. 5,785,446 to Dlugos discloses a binding device for securing bound booklets that is similar to that disclosed by Schleifenbaum et al. Dlugos discloses attaching a booklet to a perforated strip using either adhesive, an elongate plastic strip, or a string. A disadvantage of the device of Dluggos is that a booklet is secured to a perforated strip using only the outer pages of the booklet, such that the pages are easily torn and the booklet is not securely held in a binder.

U.S. Pat. No. 6,036,395 to Dalle Rose discloses a perforated device for use in a ring binder where the device includes a hinged protective strip and an adhesive. Loose notes and papers are attached to the device using the adhesive and the protective strip is then folded over the papers and the adhesive. The device is designed for securing only loose papers, and using the device to secure a booklet would secure only an outer sheet of the booklet.

US Patent Application Publication No. 2004/0057774 to Lim discloses a punchless file that includes a lever arch mechanism for clamping documents inside of a document case. However Lim does not disclose a component for securing objects such as booklets in a ring binder; rather, the punchless file of Lim is intended to be stacked independently of other document holders such as ring binders.

There is therefore a need for an improved binding device for securing booklets and other objects in ring binders.

### OBJECTS OF THE INVENTION

Therefore an object of the present invention is to overcome or at least alleviate one or more of the above limitations including providing an improved binding device for securing objects in ring binders.

A further object of the present invention is to secure booklets in ring binders.

### SUMMARY OF THE INVENTION

Accordingly, in one form, the present invention is a binding device comprising: a perforated side including holes for securing the device in a ring binder; and a clamping side including an upper jaw and a lower jaw, wherein the upper jaw and the lower jaw each include a component of a snap fit mechanism for securing the upper jaw and the lower jaw together along a longitudinal axis of the device.

Optionally, the holes for securing the device in a ring binder are positioned adjacent the snap fit mechanism.

Optionally, the holes for securing the device in a ring binder are positioned through the snap fit mechanism.

Optionally, the perforated side and the lower jaw of the clamping side are a single integrally formed component.

Optionally, the upper jaw or the lower jaw comprises at least one barb for gripping an object.

Optionally, the upper jaw and the lower jaw each comprises at least one barb for gripping an object.

Optionally, the perforated side includes two holes for receiving rings of a two-ring binder.

Optionally, the perforated side includes three holes for receiving rings of a three-ring binder.

Optionally, the upper jaw or the lower jaw comprises an inner surface including an adhesive layer.

Optionally, an advertisement is printed on the device.

The present invention thus provides a binding device for conveniently securing materials such as booklets, pamphlets, magazines and other thin objects such as CD and DVD cases in a ring binder. Booklets thus can be stored adjacent related papers in a standard two or three-ring binder. The booklets then can be opened and read while still secured in the binding device in the ring binder. Also, according to one embodiment of the present invention, booklets can be easily removed from the device, for example for copying purposes, and then the booklets can be quickly slid back between the jaws of the binding device for storage. Unlike prior art-devices that apply adhesive to only a back page of a booklet, thus subjecting the page to tearing, embodiments of the present invention can securely clamp an entire thickness of a booklet. A booklet therefore can be stored securely without damaging the booklet with holes, adhesives, or tearing.

Further features and advantages of the present invention will become apparent from the following detailed description.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, wherein like reference numerals refer to like elements, in which:

FIG. 1 is a perspective view illustrating a binding device according to one embodiment of the present invention;

FIG. 2 is a perspective view illustrating a binding device showing jaws securely snap fit together using interlocking barbs, according to another embodiment of the present invention;

FIG. 3 is an end view of the same embodiment shown in FIG. 2 of a binding device according to an embodiment of the present invention, but with a booklet 130 shown secured between the upper and lower jaws;

FIG. 4 is a further perspective view of a binding device according to an embodiment of the present invention; and

FIG. 5 is an end view illustrating a binding device showing an upper jaw and a lower jaw securely snap fit together using a snap fit mechanism comprising interlocking barbs, according to yet another embodiment of the present invention.

### DETAILED DESCRIPTION OF THE INVENTION

Embodiments of the present invention are presented as apparatus components and method steps related to a binding device. Elements of the apparatus are illustrated in concise outline form in the drawings, showing only those specific details that are necessary to understanding the embodiments of the present invention, but so as not to clutter the disclosure with excessive detail that will be obvious to those of ordinal skill in the art in light of the present description.

In this patent specification, adjectives such as first and second, left and right, top and bottom, above and below, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

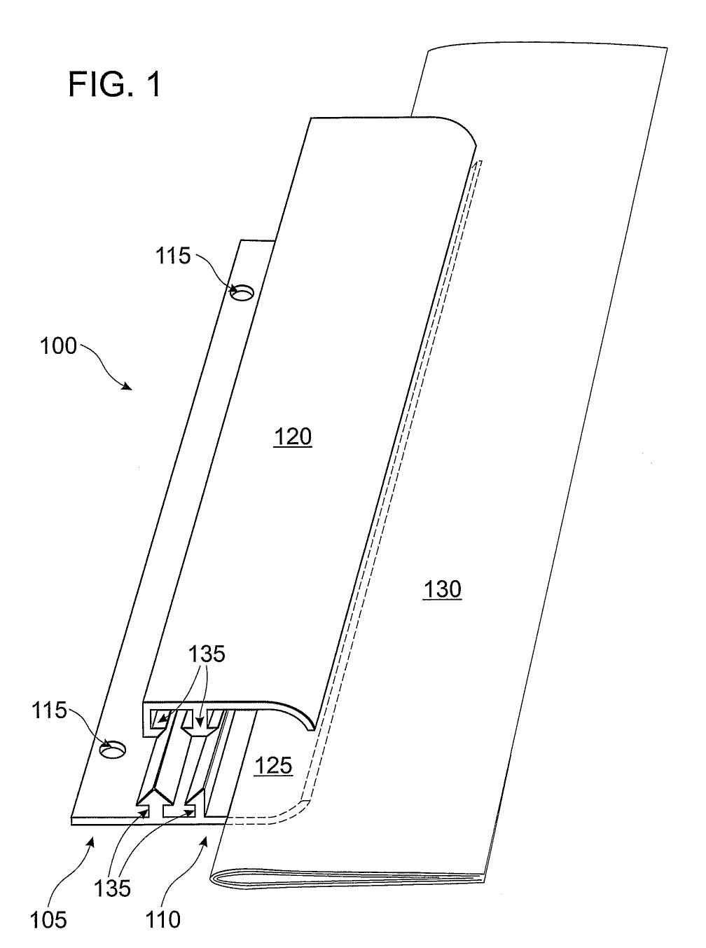

Referring to FIG. 1 there is a perspective view illustrating a binding device 100 according to one embodiment of the present invention. The binding device 100 includes a perforated side 105 and a clamping side 110. The perforated side 105 includes holes 115 for securing the device in a ring binder (not shown), such as a two-ring or three-ring binder, where the rings of the binder are placed through the holes 115. The clamping side 110 includes an upper clamping jaw 120 and a lower clamping jaw 125. Distal ends of the jaws 120, 125 are designed to hold securely clamped between them an object such as a booklet 130.

Between the perforated side 105 and the clamping side 110, the jaws 120, 125 include components of a snap fit mechanism designed to secure the jaws 120, 125 together. For example, as shown in FIG. 1, the jaws 120, 125 include barbs 135 that interlock and hold the jaws 120, 125 together.

The present invention thus provides a binding device 100 for conveniently securing objects such as booklets 130, pamphlets, magazines and other thin objects such as CD and DVD cases in a ring binder. Booklets 130 thus can be stored adjacent related papers in a standard two or three-ring binder. The booklets 130 then can be opened and read while still secured in the binding device 100 in the ring binder. Also, according to one embodiment of the present invention the booklets 130 can be easily removed from the device 100, for example for copying purposes, by sliding the booklet longitudinally out from between the jaws 120, 125, or by opening the snap fit mechanism holding the jaws 120, 125 together. The booklets 130 then can be quickly slid back between the jaws 120, 125 of the binding device 100, or the jaws 120, 125 can be again snap fit together, for storage. Unlike prior art devices that apply adhesive to only a back page of a booklet 130, thus subjecting the page to tearing, embodiments of the present invention securely clamp an entire thickness of a booklet 130 between the jaws 120, 125. The booklet 130 therefore can be stored securely without damaging the booklet 130 with holes, adhesives, or tearing.

The binding device 100 of the present invention may be fabricated from various materials including metals and molded or extruded plastics. As shown in FIG. 1, the perforated side 105 and the lower jaw 125 can be a single integrally formed component. According to one embodiment of the present invention used for securing booklets 130, the jaws 120, 125 on the clamping side 110 are generally pliable so that they bend apart when a booklet 130 is inserted between them and yet provide a constant clamping force. Alternatively, stiffer materials may be used where the jaws 120, 125 are spring-loaded to provide a clamping force. Also, inner surfaces of the jaws 120, 125 can include an adhesive layer to provide an additional means for securing an object between the jaws 120, 125. Further, the device 100 can be fabricated so that the jaws 120, 125 are permanently connected between the perforated side 105 and the clamping side 110, such as by using a strip of pliable plastic connecting the jaws 120, 125 near the snap fit mechanism. Thus when the snap fit mechanism is open, the strip of plastic acts as a hinge and prevents the jaws 120, 125 from separating completely.

Those skilled in the art will appreciate that the barbs 135 illustrated in the drawings define only one type of snap fit mechanism that can be used according to the present invention. Other types of snap fit mechanisms that securely hold the upper and lower jaws 120, 125 together, and which are capable of being repeatedly opened and closed, are also within the scope of the present invention. For example, other embodiments of the present invention can include snap fit mechanisms that have, a series of interlocking teeth so that the jaws 120, 125 can be locked closer together for use with relatively thin booklets 130, or further apart for use with relatively thick booklet 130. Also, snap fit mechanisms can be used that do not run the full longitudinal length of the device 100, as do the barbs 135, but rather are positioned in only discrete locations along the device 100. These embodiments include button shaped snaps and other mechanisms.

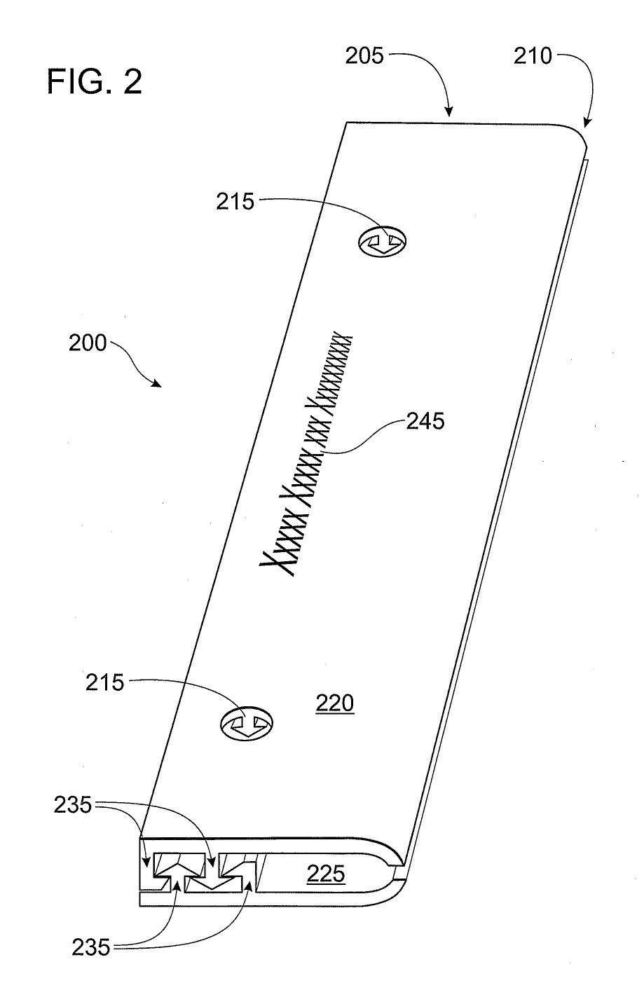

Referring to FIG. 2 there is a perspective view illustrating a binding device 200 showing an upper jaw 220 and a lower jaw 225 securely snap fit together using a snap fit mechanism comprising interlocking barbs 235, according to another embodiment of the present invention. The interlocking barbs 235 are shown in a locked closed configuration along a perforated side 205 of the device 200, which brings the upper jaw 220 and the lower jaw 225 together along a clamping side 210. Further, holes 215 for securing the device 200 in a ring binder are positioned through the snap fit mechanism, thus reducing the width of the lower jaw 225 as compared to the width of the lower jaw 125 shown in FIG. 1. A company trademark or advertisement 245, for example a name “XYZ COMPANY”, may be printed in a prominent location on the device 200 such as on the upper jaw 220. The binding device 200 thus provides an inexpensive and useful marketing object. Such branded binding devices 200 may be supplied to customers as an organizational advertisement along with booklets 130 that are appropriately secured in the devices 200.

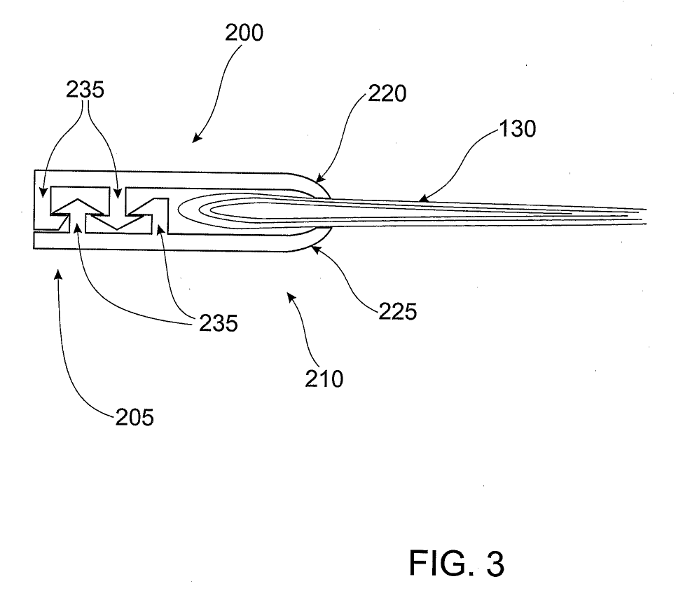

Referring to FIG. 3 there is an end view of the same embodiment shown in FIG. 2 of the binding device 200 according to an embodiment of the present invention, but with a booklet 130 shown secured between the upper and lower jaws 220, 225.

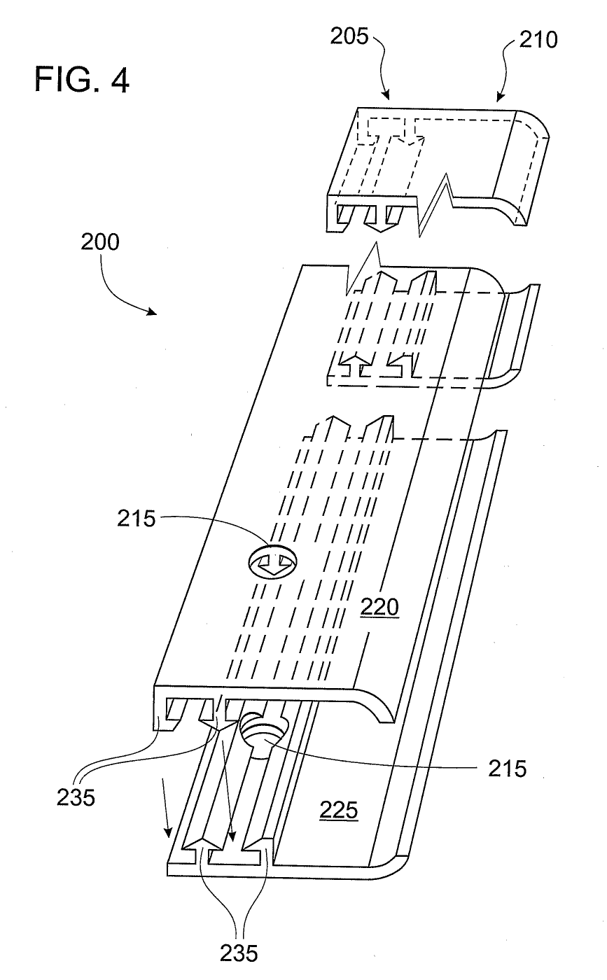

Referring to FIG. 4 there is a further perspective view of the binding device 200 in an open position, according to an embodiment of the present invention. The top half of the device 200 is foreshortened in FIG. 4 so that only one hole 215 is illustrated. The device 200 can have various dimensions such as, for example, about 21 millimeters wide by about 210 mm long. Those skilled in the art will recognize that various alternative dimensions are also possible according to other embodiments of the present invention.

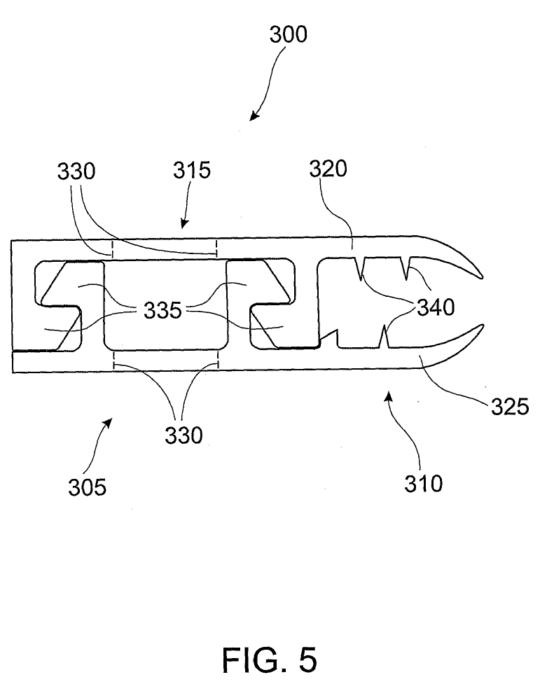

Referring to FIG. 5 there is an end view illustrating a binding device 300 showing an upper jaw 320 and a lower jaw 325 securely snap fit together using a snap fit mechanism comprising interlocking barbs 335, according to yet another embodiment of the present invention. The interlocking barbs 335 are shown in a locked closed configuration along a perforated side 305 of the device 300, which brings the upper jaw 320 and the lower jaw 325 together along a clamping side 310. Further, holes 315 (bounded by dashed lines 330) for securing the device 300 in a ring binder are positioned through the snap fit mechanism. Teeth 340 are shown extending from inner surfaces of the upper jaw 320 and the lower jaw 325 and are used for gripping an object such as the booklet 130.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art in light of the present description. Accordingly, this patent specification is intended to embrace all alternatives, modifications and variations of the present invention that have been discussed herein, and other embodiments that fall within the spirit and scope of the above described invention.

Limitations in the claims should be interpreted broadly based on the language used in the claims, and such limitations should not be limited to specific examples described herein. In this specification, the terminology “present invention” is used as a reference to one or more aspects within the present disclosure. The terminology “present invention” should not be improperly interpreted as an identification of critical elements, should not be improperly interpreted as applying to all aspects and embodiments, and should not be improperly interpreted as limiting the scope of the claims.

1. A binding device comprising:
a perforated side including holes for securing the device in a ring binder, and
a clamping side including an upper jaw and a lower jaw, wherein the upper jaw and the lower jaw each include a component of a snap fit mechanism for securing the upper jaw and the lower jaw together along a longitudinal axis of the device.

2. The binding device of claim 1, wherein the holes for securing the device in a ring binder are positioned adjacent the snap fit mechanism.

3. The binding device of claim 1, wherein the holes for securing the device in a ring binder are positioned through the snap fit mechanism.

4. The binding device of claim 1, wherein the perforated side and the lower jaw of the clamping side are a single integrally formed component.

5. The binding device of claim 1, wherein the upper jaw or the lower jaw comprises at least one barb for gripping an object.

6. The binding device of claim 1, wherein the upper jaw and the lower jaw each comprises at least one barb for gripping an object.

7. The binding device of claim 1, wherein the perforated side includes two holes for receiving rings of a two-ring binder.

8. The binding device of claim 1, wherein the perforated side includes three holes for receiving rings of a three-ring binder.

9. The binding device of claim 1, wherein the upper jaw or the lower jaw comprises an inner surface including an adhesive layer.

10. The binding device of claim 1, wherein an advertisement is printed on the device.
